(19) United States
(12) Patent Application Publication
(10) Pub. No.: US 2016/0016392 A1
(43) Pub. Date: Jan. 21, 2016

(54) MULTILAYER FILM RESISTANT TO LINEAR TEAR PROPAGATION

(71) Applicant: INFIANA GERMANY GMBH & CO. KG, Forchheim (DE)

(72) Inventors: Michael SCHUHMANN, Grosshabersdorf (DE); Siegfried SCHMITZER, Kurnach (DE)

(73) Assignee: INFIANA GERMANY GMBH & CO. KG, Forchheim (DE)

(21) Appl. No.: 14/869,105

(22) Filed: Sep. 29, 2015

Related U.S. Application Data
(63) Continuation of application No. PCT/EP2013/001242, filed on Apr. 25, 2013.

(51) Int. Cl. B32B 27/08; B32B 1/08; B32B 7/06; B32B 27/36; B32B 27/34; B32B 27/30; B32B 27/32; B32B 3/30

(52) U.S. Cl. CPC B32B 27/08; B32B 27/32; B32B 1/08; B32B 3/30; B32B 27/36; B32B 27/34; B32B 27/302; B32B 7/06; B32B 2307/5825; B32B 2307/516; B32B 2307/518; B32B 2250/03; B32B 2597/00; B32B 2250/242; B32B 2439/00; B32B 2307/7244; B32B 2307/7246; B32B 2250/24; B32B 2270/00

(57) ABSTRACT

A multilayer film comprising a layer sequence made of (a) a layer (a) composed of at least one polyethylene of low density or a mixture of a polyethylene of relatively low density and at least one aliphatic C₃-C₆ olefin homo- or copolymer, (b) a layer (b) composed of a mixture of at least one polyethylene of low density and at least one thermoplastic polymer, a layer (c) composed of at least one polyethylene of low density or a mixture of at least one polyethylene of low density and at least one aliphatic C₃-C₆ olefin homo- or copolymer.

This application is a Continuation of International Patent Application No. PCT/EP2013/001242, filed on Apr. 25, 2013, the disclosure of which patent application is incorporated herein by reference.

The present invention relates to a multilayer film comprising a layer sequence made of
(a) a layer (a) composed of at least one low-density polyethylene in the range from 0.915 to 0.935 g/cm³ or a mixture of (α) at least one relatively low-density polyethylene in the range from 0.915 to 0.935 g/cm³ and of (β) at least one aliphatic C₃-C₆ olefin homo- or copolymer,
(b) a layer (b) composed of a mixture of
   I at least one low-density polyethylene in the range from 0.915 to 0.935 g/cm³ and
   II of at least one thermoplastic polymer selected from the group comprising polystyrenes and styrene copolymers,
(c) a layer (c) composed of at least one low-density polyethylene in the range from 0.915 to 0.935 g/cm³ or a mixture of (α) at least one relatively low-density polyethylene in the range from 0.915 to 0.935 g/cm³ and of (β) at least one aliphatic C₃-C₆ olefin homo- or copolymer,
   characterized in that the tear propagation force for the multilayer film both in machine direction and perpendicularly to the machine direction is at most 1000 mN determined at a total film thickness of 50 μm by the Elmendorf test in accordance with DIN EN ISO 6383-2.

### BACKGROUND OF THE INVENTION

The prior art, e.g. GB 2 397 065 A, has already disclosed multilayer films capable of linear tear propagation which are suitable for the production of packaging. The tear propagation force of said multilayer films in machine direction is low, while the tear propagation force perpendicularly to the machine direction is considerably higher.

A factor restricting the processing of multilayer films of that type to give packaging is therefore that the lower tear propagation force predetermines the direction of tear to open packaging produced from that type of multilayer film, and thus predetermines the manner of further processing of the film to give the packaging.

Furthermore, the multilayer films capable of linear tear known from the prior art often have unsuitable mechanical properties, for example excessively low puncture resistance or unsatisfactory behavior in relation to tear and to tear propagation.

However, in particular multilayer films which are used in the form of material for packaging, e.g. single-use packaging, should exhibit maximum progressive linear behavior in relation to tear and to tear propagation, in order to avoid uncontrolled tear during opening and any resultant inappropriate access to the packaged product.

Maximum puncture resistance of the packaging material is moreover advantageous in order to facilitate handling of the packaging produced from the multilayer films. A particular reason for this is that the products packaged with the multilayer films are usually placed in mutually superposed layers or stacks during storage and transport, and unintended puncture of the packaging can occur here. This increases the quantity of rejected product.

There is therefore a need for multilayer films which feature very good properties in relation to straight and linear tear propagation in longitudinal and transverse direction, and which also feature very good puncture resistance.

It was therefore an object of the present invention to provide a multilayer film which features improved mechanical properties such as low tear propagation force in longitudinal and transverse direction and improved puncture resistance, and also straight, linear tear on opening with minimum deviations therefrom.

### SUMMARY OF THE INVENTION

This object is achieved by providing the inventive multilayer film, comprising a layer sequence made of
(a) a layer (a) composed of at least one low-density polyethylene in the range from 0.915 to 0.935 g/cm³ or a mixture of (α) at least one relatively low-density polyethylene in the range from 0.915 to 0.935 g/cm³ and of (β) at least one aliphatic C₃-C₆ olefin homo- or copolymer,
(b) a layer (b) composed of a mixture of
I at least one low-density polyethylene in the range from 0.915 to 0.935 g/cm³ and
II of at least one thermoplastic polymer selected from the group comprising polystyrenes and styrene copolymers,
(c) a layer (c) composed of at least one low-density polyethylene in the range from 0.915 to 0.935 g/cm³ or a mixture of (α) at least one relatively low-density polyethylene in the range from 0.915 to 0.935 g/cm³ and of (β) at least one aliphatic C₃-C₆ olefin homo- or copolymer,
   characterized in that the tear propagation force for the multilayer film both in machine direction and perpendicularly to the machine direction is at most 1000 mN, determined at a total film thickness of 50 μm by the Elmendorf test in accordance with DIN EN ISO 6383-2.

For the purposes of the invention, the expression “layer sequence” means that the layers a), b), and c) are present in the sequence listed and are present directly adjacent to one another. Additional layers can optionally be present on at least one surface of the layer sequence.

For the purposes of the invention, the expressions “low-density polyethylene” and “LDPE” mean unfoamed low-density polyethylene which features a high degree of branching of the molecules.

In the invention, the expression “machine direction” means the production direction in which the multilayer film is produced and optionally rolled up, and the expressions “perpendicularly to the machine direction” means the direction at right angles to the production direction of the multilayer film.

In one preferred embodiment, the tear propagation force for the multilayer film of the invention both in machine direction and perpendicularly to the machine direction is at most 800 mN, determined when the total film thickness is 50 μm by the Elmendorf test in accordance with DIN EN ISO 6383-2.

It is further preferable that the ratio of the tear propagation force in machine direction to the tear propagation force perpendicularly to the machine direction, determined at a total film thickness of 50 μm by the Elmendorf test in accordance with DIN EN ISO 6383-2 for the multilayer film of the invention, is from 2:1 to 1:2, preferably from 1.5:1 to 1:1.5.

The multilayer film of the invention also features high puncture resistance, preferably of at least 30 N, particularly preferably at least 40 N, determined at a total film thickness of 50 μm in accordance with ASTM E 154-88 part 10.

In one preferred embodiment, the density of the polyethylene of each of the layers (a), (b), and (c) is in the range from 0.920 to 0.935 g/cm³.

It is preferable that the melting point of the polyethylene of the layers (a), (b), and (c), determined in accordance with DIN EN ISO 3146, is at most 118° C., particularly at most 116° C.

Both the layer (a) and the layer (c) can, while being identical or different from one another, be composed of the following as polymer components of the respective layer: a mixture (α) of at least one relatively low-density polyethylene in the range from 0.915 to 0.935 g/cm³, preferably from 0.920 to 0.935 g/cm³, and of (β) at least one aliphatic C₃-C₆ olefin homo- or copolymer, preferably at least one propylene homo- or copolymer, particularly preferably a polypropylene and/or propylene copolymer.

It is preferable that the polymer mixture of (α) and (β) consists to an extent of at least 50% by weight, particularly preferably of at least 70% by weight to 95% by weight, based in each case on the total weight of the polymer mixture (α) and (β), of polyethylene component (α).

It is preferable that at least one of the layers (a) and (c) is a surface layer of the multilayer film of the invention and is preferably heat-sealable.

The layers (a) and (c) can be identical or different, preferably being identical.

The thickness of the layer (a) and, respectively, the layer (c) of the multilayer film of the invention is preferably from 5 μm to 75 μm, particularly preferably from 10 μm to 50 μm, especially preferably from 15 μm to 25 μm.

In one preferred embodiment of the multilayer film of the invention, the layer (a) and the layer (c) have an identical layer structure, and preferably an identical thickness, and/or an identical composition of the polymer component(s) respectively the polymer components.

The layer (b) of the multilayer film of the invention is based on a mixture

I of at least one low-density polyethylene in the range from 0.915 to 0.935 g/cm³, preferably from 0.920 to 0.935 g/cm³, and

II of at least one thermoplastic polymer selected from the group comprising polystyrenes and styrene copolymers.

Of preferential suitability as polymer component II are polystyrenes, copolymers of styrene/acrylonitrile, copolymers of styrene/butadiene, copolymers of styrene/(meth)acrylate, copolymers of styrene/acrylonitrile/(meth)acrylates, copolymers of styrene/acrylonitrile/butadienes, particularly preferably at least one polystyrene.

In one preferred embodiment, the glass transition temperature T_{g} of the polymer component II, determined in accordance with ISO 11357-1, -2, -3 (DSC), is at least 60° C., preferably at least 80° C., and very particularly preferably at least 90° C.

It is preferable that the proportion of the styrene in the styrene copolymers of the layer (b) is at least 40% by weight, particularly preferably at least 50% by weight, based on the total weight of the styrene copolymer.

In one particular embodiment, the proportion of the polymer component II in the layer (b) is at most 50% by weight, preferably at most 40% by weight, and particularly preferably from 20 to 35% by weight, based on the total weight of polymer components I and II of the layer (b).

It is preferable that the thickness of the layer (b) is from 5 μm to 100 μm, particularly from 10 μm to 50 μm, very particularly from 15 μm to 30 μm.

It is preferable that the thickness of the layer (b) is at least 20%, particularly from 25 to 75%, based on the total thickness of the layer sequence (a)-(c).

It is preferable that the total thickness of the layer sequence (a)-(c) is at least 30%, particularly from 50% to 100%, based on the total thickness of the multilayer film.

The multilayer film of the invention can be produced by any desired production processes, e.g. lamination, extrusion, preferably coextrusion, very particularly preferably blown-film coextrusion.

In another embodiment, the form in which the multilayer film of the invention is produced and processed can be that of respective individual layers, that of partial composite, or that of entire multilayer film in the form of a tubular film.

In another preferred embodiment, at least the layer sequence (a)-(c) is produced in the form of a preferably coextruded tubular film.

The blow-up ratio of the coextruded layer sequence (a)-(c) here can preferably be at least 1:1, particularly preferably at least 1.5:1, very particularly preferably at least 2:1.

In another embodiment, the multilayer film can also be produced in the form of laminate comprising the coextruded layer sequence (a)-(c) and optionally at least one further layer.

A further layer present can be a barrier layer (d) and/or a layer (e) based on at least one thermoplastic polymer as substrate layer, where the barrier layer optionally is bonded directly respectively by way of an adhesion-promoter layer to the other layers of the film composite.

In another preferred embodiment, the entire multilayer film has the form of a preferably coextruded tubular film and can optionally be processed to give a flat film.

The form in which the inventive multilayer film is produced is particularly preferably that of a multilayer blown film, preferably produced via extrusion, in particular via blown-film coextrusion.

In another embodiment, the form in which the multilayer film can be produced and processed is to some extent or entirely that of a cast film.

It is preferable that the multilayer film produced in the form of cast film has been orientated at least monoaxially with a orientation ratio of at least 1:1.5, particularly at least 1:2, particularly preferably from 1:2 to 1:4.

In one preferred embodiment, the multilayer film produced in the form of cast film can be orientated monoaxially in longitudinal direction with a orientation ratio of preferably at least 1:1.5, particularly preferably of at least 1:2, very particularly preferably from 1:2 to 1:4.

In another preferred embodiment, the multilayer film produced in the form of biaxially orientated cast film has a ratio of longitudinal to transverse orientation of preferably at least 1:1, particularly preferably at least 1.1:1, and very particularly preferably at least 1.2:1.

As stated above, individual layers, or all of the layers, of the inventive multilayer film can be produced by (co)extrusion, preferably in the form of flat film extrudates (=cast films) or optionally in the form of multilayer tubular films. The extruded films in this way can be orientated to the necessary extent during production or preferably immediately after extrusion.

If individual layers of the multilayer film to be used according to the invention are produced separately by one of the above processes, or if individual layers have inadequate adhesion within the composite, it can be necessary that the structure of the multilayer film also comprises an adhesion-promoter layer. This can by way of example be applied in the form of melt or in the form of a liquid preparation, for example in the form of solution or dispersion, by usual methods, such as spraying or casting, onto one of the layers that requires bonding in the multilayer film used in the invention, for example to the layer (c), and bonded to one of the other layers. Alternatively, it is also optionally possible to apply the adhesion-promoter layer to the layer (c) by extrusion and to bond it directly to another layer, such as a barrier layer, or to a layer composite.

As already stated, the inventive multilayer film can comprise further layers alongside the layer sequence (a)-(c). These layers can be coextruded with the layer sequence (a)-(c) or laminated onto the layer sequence (a)-(c), as appropriate for the nature of the further layers.

The inventive multilayer film can therefore comprise a barrier layer (d) alongside the layer sequence (a)-(c).

This barrier layer (d) preferably serves as gas-barrier layer, particular preference being given to an oxygen-barrier layer and/or a water-vapor-barrier layer.

The barrier layer (d) can preferably be based on at least one ethylene-vinyl alcohol copolymer, on at least one polyvinyl alcohol, on at least one metal, preferably aluminum, or on at least one metal oxide, preferably SiOx or aluminum oxide and this metal can take the form of film or, in the form of a layer of metal oxide, can have been applied from the vapor phase.

The barrier layer (d) can be based on an ethylene-vinyl alcohol copolymer (EVOH) which has been obtained by, in essence, complete hydrolysis of a corresponding ethylene-containing polyvinyl acetate (EVAc). The degree of hydrolysis of said fully hydrolyzed ethylene-containing polyvinyl acetates is 98%, and the proportion of ethylene therein is from 0.01 to 80 mol %, preferably from 1 to 50 mol %.

The barrier layer (d) can also be based on a polyvinyl alcohol which has been obtained by a nearly complete hydrolysis of a polyvinyl acetate (PVA), and which as a fully hydrolyzed polyvinyl acetate has a degree of hydrolysis 98%.

To the extent that a metal has been used as barrier layer (d), this is preferably made of aluminum applied from the vapor phase.

The thickness of the barrier layer (d) is preferably from 1 μm to 100 μm, with preference from 2 μm to 80 μm, with particular preference from 3 μm to 60 μm, with very particular preference from 4 μm to 40 μm; the layer thickness of a metal oxide or metal applied from the vapor phase here is in the A range.

The inventive multilayer film can optionally comprise, besides the layer sequence (a)-(c) and any barrier layer (d) present, a layer (e) based on at least one thermoplastic polymer, as substrate layer.

Materials suitable for the production of the layer (e) are preferably thermoplastic polymers selected from the group comprising polyolefins, polyamides, polyesters, polystyrenes, and copolymers of at least two monomers from the polymers mentioned, particularly preferably olefin homo- or copolymers and/or polyesters.

The inventive multilayer film can optionally have, on at least one of its surfaces, a release layer preferably based on at least one hardened polysiloxane, preferably when not serving as packaging material.

The inventive multilayer film can optionally also have, on both surfaces, a release layer preferably based on at least one cured polysiloxane, when the multilayer film is optionally not serving as packaging material.

For the purposes of the present invention, the expression “polysiloxane” means compounds having polymer chains composed of alternating atoms of silicon and of oxygen. A polysiloxane is based on n repeating siloxane units (—[Si(R₂)—O]—)ₙ which in each case mutually independently have disubstitution by two organic moieties R, where R is preferably in each case R¹ or OR¹, and R¹ is in each case an alkyl moiety or an aryl moiety.

It is preferable that the cured polysiloxane of the invention is based on a repeating dialkylsiloxane unit or on a repeating alkylarylsiloxane unit. The number of Si—O bonds possessed by an individual siloxane unit, in each case based on a tetravalent silicon atom, can be used to divide said units into terminal monofunctional siloxanes (M) having one Si—O bond, difunctional siloxanes (D) having two Si—O bonds, trifunctional siloxanes (T) having three Si—O bonds, and tetrafunctional siloxanes (Q) having four Si—O bonds. The polysiloxane used in the invention preferably has a crosslinked ring- or chain-type structure, particularly preferably a crosslinked chain-type structure, linked via (D), (T), and/or (Q) units to give a two- or three-dimensional network. The number n of repeating siloxane units (—[Si(R₂)—C]—)ₙ in the polysiloxane chain is termed the degree of polymerization of the polysiloxane.

The optionally present release layer is preferably based on at least one hardened, i.e. crosslinked polysiloxane selected from the group comprising addition-crosslinked, preferably metal-catalyzed addition-crosslinked, condensation-crosslinked, free-radical-crosslinked, cationically crosslinked, and/or moisture-crosslinked polysiloxanes.

It is preferable that the release layer is based on at least one cured polysiloxane which has been cured via thermal curing, via curing by electromagnetic radiation, preferably via UV radiation, or via exposure to moisture. It is preferable that the release layer of the inventive multilayer film is based on at least one cured polysiloxane selected from the group consisting of polydialkylsiloxanes, preferably polydimethylsiloxanes, and polyalkylarylsiloxanes, preferably polymethylphenylsiloxanes, cured via UV radiation.

The thickness of the optionally present release layer of the inventive multilayer film is preferably from 0.1 μm to ≦3 μm, preferably from 0.2 μm to 1.5 μm.

The layer (a), the layer (b), the layer (c), and also the optionally present barrier layer (d) and substrate layer (e), and the optionally present adhesion-promoter layers made of the stated polymer components can, if necessary, in each case mutually independently comprise additives selected from the group consisting of antioxidants, antiblocking agents, antifogging agents, antistatic agents, antimicrobial ingredients, light stabilizers, UV absorbers, UV filters, dyes, color pigments, stabilizers, preferably heat stabilizers, process stabilizers, and UV and/or light stabilizers, preferably based on at least one sterically hindered amine (HALS), processing aids, flame retardants, nucleating agents, crystallization agents, lubricants, optical brighteners, flexibilizing agents, sealing agents, plasticizers, silanes, spacers, fillers, peel additives, waxes, wetting agents, surface-active compounds, preferably surfactants, and dispersing agents.

Care has to be taken here that the addition of additives or the amount of these does not impair the tear propagation behavior of the inventive multilayer film.

The layer (a), the layer (b), the layer (c), and also the optionally present layers (d) and (e), and the optionally present adhesive-promoter layers can, in each case mutually independently, comprise at least 0.01-30% by weight, preferably at least 0.1-20% by weight, based in each case on the total weight of an individual layer, of at least one of the abovementioned additives. The form in which the additives are incorporated for this purpose into the respective layer can be that of a masterbatch in polyolefins or olefin copolymers.

The inventive multilayer film can be printed, and/or colored, and/or embossed.

The inventive multilayer film can be optionally equipped, on at least one of its surfaces, with an adhesive layer.

Examples of suitable adhesives for the adhesive layer are pressure-sensitive adhesives based on acrylates, on natural rubbers, or on styrene-isoprene-styrene block copolymers, and silicone-based adhesives, e.g. polydimethylsiloxane and polymethylphenylsiloxane.

The inventive multilayer film is preferably suitable as packaging material.

The invention therefore further provides the use of a multilayer film of the invention as packaging material.

The invention therefore further provides the use of the inventive multilayer film for the production of a packaging element.

The inventive multilayer film is in particular suitable for the production of a packaging element and/or of packaging, preferably of bag packaging, of individual-portion packaging, of a sachet, or of a stickpack.

The invention therefore further provides the use of an inventive multilayer film for the production of packaging, preferably of bag packaging, of individual-portion packaging, of a sachet, or of a stickpack.

The invention therefore further provides packaging in the form of bag packaging, of individual-portion packaging, of a sachet, or of a stickpack made of an inventive multilayer film.

The inventive multilayer film is preferably used for the production of easy-to-open packaging.

The invention therefore further provides easy-to-open packaging made of a multilayer film of the invention. The packaged product can be removed without difficulty from packaging of this type, since tearing to open the packaging and tear propagation therein leads to a straight, linear tear. The risk of spillage is thus minimized.

The inventive multilayer film is preferably suitable for the production of an easy-to-open packaging element, e.g. in the form of a lid of two-part packaging. This type of an inventive two-part packaging comprises the lid made of an inventive multilayer film and a container, which preferably has been designed as tray made of thermoformed plastic.

The invention therefore further provides an easy-to-open packaging element, preferably a lid, made of the inventive multilayer film.

A feature of the inventive packaging is that it exhibits easy and straight, linear tear propagation independently of the direction of production of the inventive multilayer film used, i.e. both in machine direction and also perpendicularly thereto, and is therefore easy to open. A notch or a point of weakening can be applied in order to assist the tearing to open the inventive packaging. If a notch or a point of weakening is applied, this should preferably be present in the region of the seal seam in the direction of tear for opening.

Another feature of the inventive packaging is that it has high puncture resistance, and is therefore easier to handle, i.e. in comparison with films with similar tear propagation behavior it is less susceptible to damage caused by exposure to impacts during storage, transport, and sale.

In another preferred embodiment, an inventive multilayer film is also suitable as release film.

The invention therefore further provides the use of an inventive multilayer film as release film, in particular with a release layer as surface layer.

Since one of the important factors in uses of this type is that the release film, optionally with the protected substrate, at the desired length, can be removed easily and along a straight, linear course, the inventive multilayer film is particularly suitable as release film and protective film because of its behavior in relation to removal by tearing and to tear propagation.

In this type of embodiment, the inventive multilayer film can be used as protective and release film for adhesive tapes.

The invention therefore further provides the use of an inventive multilayer film as protective and release film for adhesive tapes.

Determination of Tear Propagation Resistance

The tear propagation force (tear propagation resistance) in machine direction (MD) and perpendicularly to the machine direction (CD) of an inventive multilayer film having a specific total film thickness is determined in each case by the Elmendorf method in accordance with ISO 6383-2, and is stated in [mN].

Determination of Puncture Resistance

The puncture resistance of an inventive multilayer film having a specific total film thickness is determined in accordance with ASTM E 154-88 part 10, and is stated in [N].

Determination of Behavior in Relation to Straight, Linear Tear Propagation

The behavior of an inventive multilayer film in relation to straight, linear tear propagation is assessed by measuring the deviation from a straight, linear course during tearing (tear propagation). This is stated in [mm].

From each of the inventive multilayer film having a specific total film thickness, of which the tear propagation behavior is to be determined, 10 samples are cut in such a way that their length is 100 mm parallel to the machine direction (MD) and their width is 50 mm perpendicularly to the machine direction (CD). 10 samples are also cut in such a way that their length is 100 mm perpendicularly to the machine direction (CD) and their width is 50 mm parallel to the machine direction (MD).

A 50 mm incision, in the machine direction and parallel to the longitudinal side, is made in the middle of the width side of each of the individual samples, and underneath the incision each sample is provided, centrally and parallel to the longitudinal side, with a double-sided adhesive tape of width 20 mm and of length 90 mm. A marker is used to mark a linear extrapolation line from the incision, and this line serves as straight, linear tear line for measuring the deviation.

The tear behavior of the individual samples is determined under standard conditions of temperature and humidity (DIN 50014-23/50-2). To this end, the double-sided adhesive tape adhering to the material is used to fix one side of each of the individual samples at a defined angle of 45° [β] on a metal plate of width 100 mm and of length 350 mm.

The metal plate is clamped into the lower clamp of an electronic tear tester (Zwick). A double-sided adhesive tape is used to fix the incision end of the free side (“the free trouser leg”) of the individual samples on a stiff strip of film of length 400 mm, and this is clamped into the upper clamp of the tear tester.

The two sides of the individual samples are now pulled apart at an angle of 175° and with a velocity of 500 mm/min until the sample is completely separated.

The linear tear propagation behavior of the samples is assessed by determining the maximal deviation A of the tear in mm from the marking line (straight, linear tear extrapolating the incision) at the end of the sample.

The average value is calculated from the maximal deviations A measured for the 10 samples with the dimensions 100 mm (MD)×50 mm (CD). This serves for assessment of linear tear behavior in machine direction (MD).

Correspondingly, the average value is likewise calculated from the maximal deviations A measured for the 10 samples with the dimensions 100 mm (CD)×50 mm

(MD). This serves for assessment of linear tear behavior perpendicularly to the machine direction (CD).

### EXAMPLES

The inventive examples and comparative examples below serve to illustrate the invention, but are not being interpreted as restrictive.

### I. Chemical Characterization of the Polymers Used

Lupolen 2420 F: LDPE from Basell; density (ISO 1183): 0.927 g/cm³; melting point (ISO 3146): 114° C.
Innovex LL 0209 AA: LLDPE from Ineos; comprises 1-butene as comonomer; density (ISO 1183): 0.920 g/cm³
Polystyrene 1340: polystyrene from Total Petrochemicals; density (ISO 1183): 1.05 g/cm³; vicat softening temperature VST/A/50 (ISO306): 98° C.
Styrolux 3 G 55: styrene-butadiene block copolymer from BASF; density (ISO 1183): 1.01 g/cm³; vicat softening temperature VST/A/50 (ISO306): 67° C.
Exceed 1018 CA: metallocene ethylene-hexene copolymer from ExxonMobil; density 0.918 g/cm³; melting temperature (ISO3146): 119° C.;

### II. Production of an Inventive Multilayer Film or of a Single Layer and a Multilayer Comparative Film

According to comparative example (ce1) the film consists of one layer and has a total thickness of 50 μm. According to comparative example (ce2) and inventive example (ie1), the film consists of three layers, and has an overall thickness of 50 μm in each case. The layer thickness ratios are 1:2:1. The individual layers of the multilayer film ce1 and ie1 are directly adjacent to one another in the sequence in which they are listed below. The films ce1, ce2, and ie1 were produced in each case by blown-film coextrusion. The blow-up ratio was in each case 2:1.

### III. Inventive Example and Comparative Examples

All of the % data below are % by weight.

### III.1 Inventive Example 1

Layer (a) (12.5 μm): 100% of Lupolen 3020 H
Layer (b) (25 μm): 80% of Lupolen 3020 H and 20% of Polystyrene 1340
Layer (c) (12.5 μm): 100% of Lupolen 3020 H

### III.2 Comparative Example 1

Layer (a) (50 μm): 80% of Innovex LL 0209 AA and 20% Polystyrene 1340

### III.3 Comparative example 2

Layer (a) (12.5 μm): 100% Exceed 1018 CA
Layer (b) (25 μm): 70% Styrolux 3 G 55 and 30% Polystyrene 1340
Layer (c) (12.5 μm): 100% Exceed 1018 CA

### IV. Determination of Elmendorf Tear Resistance, of Puncture Resistance, and of Deviation from Straight, Linear Tear

Tear resistance (Elmendorf) in machine direction (MD) and perpendicularly to the machine direction (CD), and puncture resistance, and deviation from straight, linear tear during tear propagation in machine direction (MD) and perpendicularly to the machine direction (CD), in each case at a total film thickness of 50 μm were determined for the multilayer film of the inventive example (ie1) and for the monofilm according to comparative example (ce1) and multilayer film according to comparative example (ce2), in each case by the methods described above.

| | | | |
|---|---|---|---|
| | Tear | | |
| Inventive | propagation | | |
| example/ | force | Puncture | Deviation A |
| comparative | [mN] | resistance | [mm] |

| example | MD | CD | [N] | MD | CD |
|---|---|---|---|---|---|
| ce1 | 1232 | 309 | 74 | 2 | >25 |
| ce2 | 287 | 154 | 96 | >25 | 24 |
| ie1 | 201 | 420 | 44 | 1.5 | 4.0 |

What is claimed is:

1. A multilayer film comprising a layer sequence made of
(a) a layer (a) composed of at least one low-density polyethylene in the range from 0.915 to 0.935 g/cm³ or a mixture of (α) at least one relatively low-density polyethylene in the range from 0.915 to 0.935 g/cm³ and of (β) at least one aliphatic C₃-C₆ olefin homo- or copolymer,
(b) a layer (b) composed of a mixture of
I at least one low-density polyethylene in the range from 0.915 to 0.935 g/cm³ and
II of at least one thermoplastic polymer selected form the group consisting of polystyrenes and styrene copolymers,
(c) a layer (c) composed of at least one low-density polyethylene in the range from 0.915 to 0.935 g/cm³ or a mixture of (α) at least one relatively low-density polyethylene in the range from 0.915 to 0.935 g/cm³ and of (β) at least one aliphatic C₃-C₆ olefin homo- or copolymer,
wherein the tear propagation force for the multilayer film both in machine direction and perpendicularly to the machine direction is at most 1000 mN, and the ratio of the tear propagation force in machine direction to the tear propagation force perpendicularly to the machine direction, in each case determined at a total film thickness of 50 μm by the Elmendorf test in accordance with DIN EN ISO 6383-2, is from 2:1 to 1:2.

2. The multilayer film as claimed in claim 1, wherein the ratio of the tear propagation force in machine direction to the tear propagation force, determined at a total film thickness by the Elmendorf test in accordance with DIN EN ISO 6383-2 for the multilayer film, is in each case from 1.2:1 to 1:1.2.

3. The multilayer film as claimed in claim 1, wherein the tear propagation force for the multilayer film both in machine direction and perpendicularly to the machine direction is at most 800 mN, determined at a total film thickness of 50 μm by the Elmendorf test in accordance with DIN EN ISO 6383-2.

4. The multilayer film as claimed in claim 1, wherein the puncture resistance of the multilayer film is at least 30 N, determined at a total film thickness of 50 μm in accordance with ASTM E 154-88 part 10.

5. The multilayer film as claimed in claim 1, wherein the density of the polyethylene of each of the layers (a), (b), and (c) is in the range from 0.920 to 0.935 g/cm³.

6. The multilayer film as claimed in claim 1, wherein the layer (a) and, respectively, (c) is composed of a mixture of (α) at least one polyethylene with a density of from 0.920 to 0.935 g/cm³ and of (β) at least one polypropylene and/or propylene copolymer.

7. The multilayer film as claimed in claim 1, wherein the mixture of (α) and (β) consists to an extent of at least 50% by weight, based on the total weight of the mixture, of polyethylene component (α).

8. The multilayer film as claimed in claim 1, wherein the polyethylene component is identical in each polyethylene-containing layer (a)-(c).

9. The multilayer film as claimed in claim 1, wherein the glass transition temperature T_{g} of the polymer component II of the layer (b), determined in accordance with ISO 11357-1, -2, -3 (DSC), is at least 60° C.

10. The multilayer film as claimed in claim 1, wherein polymer component II comprises at least one polymer selected from the group consisting of polystyrene, copolymers of styrene/acrylonitrile, copolymers of styrene/butadiene, copolymers of styrene/(meth)acrylates, copolymers of styrene/acrylonitrile/(meth)acrylates, and copolymers of styrene/acrylonitrile/butadienes.

11. The multilayer film as claimed in claim 10, wherein the styrene copolymers take the form of block copolymers built in each case of at least one block composed of repeating structural units of each of the monomers of the stated copolymers in each case.

12. The multilayer film as claimed in claim 1, wherein the proportion of the polymer component II in the layer (b) is at most 50% by weight, based on the total weight of the mixture of the polymer components I and II of the layer (b).

13. The multilayer film as claimed in claim 1, wherein the proportion of the styrene in the styrene copolymer of the layer (b) is at least 40% by weight, based on the total weight of styrene copolymer.

14. The multilayer film as claimed in claim 1, wherein the thickness of the layer (b) is at least 20%, based on the total thickness of the layer sequence (a)-(c).

15. The multilayer film as claimed in claim 1, wherein the total thickness of the layer sequence (a)-(c) is at least 30%, based on the total thickness of the multilayer film.

16. The multilayer film as claimed in claim 1, wherein the entire multilayer film consists of the layer sequence (a)-(c) which takes the form of a coextruded tubular film.

17. The multilayer film as claimed in claim 16, wherein the blow-up ratio of the coextruded layer sequence (a)-(c) is at least 1:1.

18. The multilayer film as claimed in claim 1, wherein the form in which the multilayer film has been produced is at least to some extent that of cast film.

19. The multilayer film as claimed in claim 18, wherein the multilayer film produced in the form of cast film has been orientated at least monoaxially with a orientation ratio of at least 1:1.5.

20. The multilayer film as claimed in claim 18, wherein the biaxially orientated multilayer film produced in the form of cast film has a ratio of longitudinal to transverse orientation of at least 1:1.

21. The multilayer film as claimed in claim 1, wherein the multilayer film comprises, alongside the layer sequence (a)-(c), at least one barrier layer (d), composed of at least one ethylene-vinyl alcohol copolymer, of at least one polyvinyl alcohol, of at least one metal, or of at least one metal oxide.

22. The multilayer film as claimed in claim 1, wherein the multilayer film comprises, as substrate layer, alongside the layer sequence (a)-(c), at least one layer (e) based on at least one thermoplastic polymer selected from the group consisting of polyolefins, polyamides, polyesters, polystyrenes, and copolymers of at least two monomers from the polymers mentioned.

23. The multilayer film as claimed in claim 1, wherein the multilayer film is printed, and/or colored, and/or embossed.

24. The multilayer film as claimed in claim 1, wherein the multilayer film has, on at least one of its surfaces, a release layer, based on at least one cured polysiloxane.

25. The multilayer film as claimed in claim 1, wherein the multilayer film is equipped, on at least one of its surfaces, with an adhesive layer.

26. A packaging material comprising the multilayer film of claim 1.

27. A method for the production of a packaging element and/or of an entire packaging, wherein said packaging element or entire packaging is produced from the multilayer film of claim 1.

28. A release film or protective film comprising the multilayer film of claim 24.

29. An easy-to-open packaging or an easy-to-open packaging element, made of a multilayer film as claimed in claim 1.

30. The easy-to-open packaging in the form of bag packaging, of individual-portion packaging, of a sachet, or of a stickpack made of a multilayer film as claimed in claim 1.
